(19) United States
(12) Patent Application Publication
(10) Pub. No.: US 2003/0177242 A1
(43) Pub. Date: Sep. 18, 2003

(54) Trigger-based session completion using external parties

(75) Inventors: Dirk Trossen, Cambridge, MA (US); Dana Pavel, Burlington, MA (US)

Correspondence Address: BANNER & WITCOFF, 1001 G STREET N W, SUITE 1100, WASHINGTON, DC, 20001, US

(73) Assignee: NOKIA, Inc., Irving, TX

(21) Appl. No.: 10/179,196

(22) Filed: Jun. 26, 2002

Related U.S. Application Data
(60) Provisional application No. 60/364,019, filed on Mar. 15, 2002.

(51) Int. Cl. G06F 15/16

(52) U.S. Cl. 709/227

(57) ABSTRACT

A method for performing Internet call processing related to the completion of session initiation requests is provided. The session initiation requests include one or more triggers. Based on the detection of one or more triggers, a call processing entity involved with processing the session initiation request transfers call processing to one or more third parties. Each third party performs additional call processing and returns a result to the call processing entity. Based on reception of the result, the call processing entity continues processing the session initiation request. The URI of one or more third parties may be specified in the session initiation request. Also, one or more third parties may be pre-specified. A special trust relationship may exist between a terminal related to the session initiation request and one or more third parties, and the third parties may therefore perform call processing using context specific information or confidential information.

This application claims priority to U.S. Provisional Application Serial No. 60/364,018 entitled “Trigger-Based Session Completion Using External Parties,” filed Mar. 15, 2002, the contents of which are incorporated by reference herein.

### FIELD OF THE INVENTION

This invention relates generally to telecommunications networks. More particularly, the invention concerns systems and methods for completing session initiation requests based on the use of external parties and triggers within the requests.

### BACKGROUND OF THE INVENTION

Internet telephony is becoming increasingly popular as a means to avoid the high cost of conventional wired-line telephone charges. It is also becoming popular due to additional features that may be provided over standard telephone usage, such as the availability of inexpensive multimedia sessions. Other features are also available due to the transfer of data in addition to voice messages, such as executing preferences in telephone software and call processing software. Further features may be provided through methods for initiating and processing call sessions.

Session Initiation Protocol (SIP) is a standard protocol for initiating an interactive user session involving multimedia elements such as video, games, voice, virtual reality and the like. In addition to initiating multimedia sessions, SIP can establish and maintain Internet telephone calls. SIP provides application layer signaling that normally runs over UDP or TCP. The SIP standard is described further in IETF RFC 2543 entitled “SIP: Session Initiation Protocol” dated March 1999. As a request-response protocol, SIP accepts requests from clients and delivers responses from servers with participants identified by URIs. SIP establishes call parameters at either end of the communication session and handles call transfer and call termination.

Call processing languages may be used to tailor and adapt call control services to user preferences based on context information such as location, time, availability, or any other personal context information. The Internet Engineering Task Force (IETF) is currently standardizing a call processing language known as “CPL,” thereby enabling such call processing functionality (see IETF Internet Draft “draft-ietf-iptel-cpl-06.txt,” which expires July 2002). The IETF approach, however, is restricted to location and time information. Additionally, in the IETF approach, the entire call processing logic has been assumed to be located in the SIP-compliant proxy.

Context-specific language extensions in CPL and the execution of context-specific functionality in an external trusted third party call processing entity have been discussed in related U.S. patent application Ser. No. 09/995,568 entitled “External Trusted Party Call Processing In SIP Environments.” As discussed therein, an “external-switch” element initiates a transfer of call processing to a URI specified as a parameter of the external-switch. The URI corresponds to an external trusted third party, which proceeds with context specific processing according to its programming.

### SUMMARY OF THE INVENTION

The present invention provides methods for completing session initiation requests using triggers within the requests. The triggers cause the transfer of call processing from a call processing entity to one or more external third parties. As such, call processing of a session initiation request is transferred to a third party when an associated trigger is detected. The third party to which call processing is transferred may be identified within the session initiation request. Further, the third party may be a trusted third party with whom a user associated with the session request has a strong trust relationship. The call processing procedures performed at the external third party may be based on the trigger that caused the transfer.

The use of triggers in session initiation requests provides a large degree of flexibility in call processing, while keeping the processing at a call processing entity relatively simple. The triggers also permit the use of third parties, which may provide specialized processing and may perform processing based on private user context information. A call processing language, such as CPL, permits the introduction of actions for detecting the triggers and switches for transferring call processing based on the detection of associated triggers.

In one embodiment of the invention, the session initiation request is a session initiation protocol (SIP) INVITE message and the triggers are keywords contained in a sub-field of the original-destination field of the INVITE message. In such an embodiment, the call processing entity is a SIP-compliant proxy and the third parties are remote proxies.

In other embodiments of the invention, computer-executable instructions for implementing the disclosed methods are stored on computer-readable media. In one embodiment, computer-executable instructions are written in the language known as CPL. Other features and advantages of the invention will become apparent with reference to the following detailed description and figures.

### BRIEF DESCRIPTION OF THE DRAWINGS

FIG. 1 shows an architecture that supports a method for performing Internet call processing in accordance with one embodiment of the present invention, and illustrates related message flows;

FIG. 2 shows a detailed portion of the CPL script stored on the SIP proxy of FIG. 1;

FIG. 3 shows a functional diagram of a call processing entity according to one embodiment of the present invention;

FIG. 4 shows a functional diagram of a terminal according to an embodiment of the present invention;

FIG. 5 shows an architecture that supports a method for performing Internet call processing in accordance with another embodiment of the present invention, and illustrates related message flows; and

FIG. 6 shows another architecture that supports a method for performing Internet call processing in accordance with a further embodiment of the present invention, and illustrates related message flows.

### DETAILED DESCRIPTION OF THE INVENTION

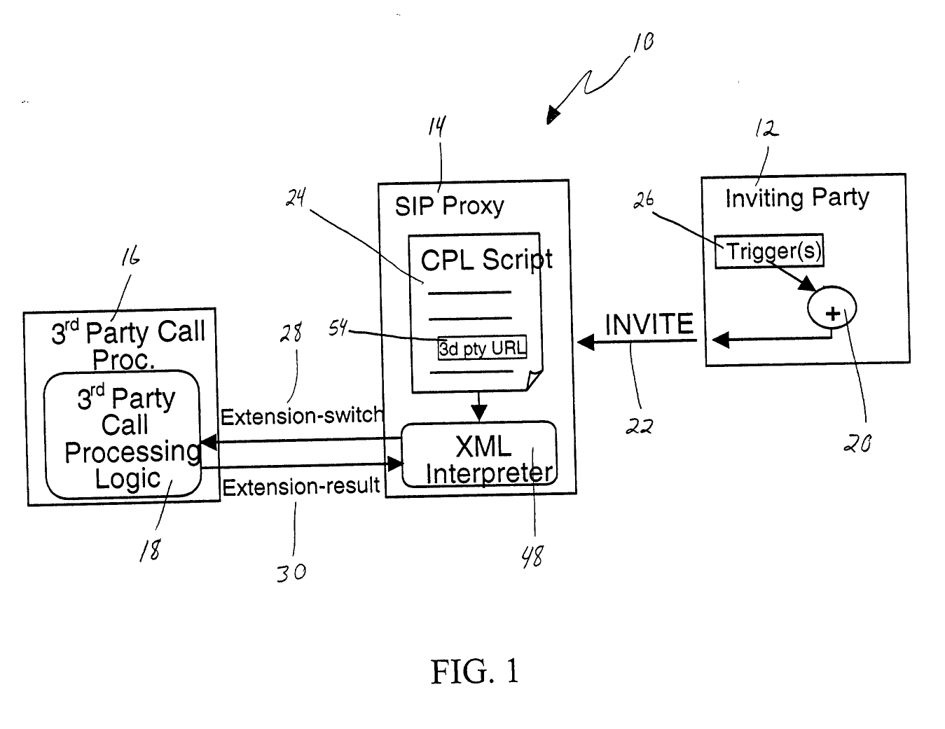

The invention may be embodied in various forms. Referring now to FIG. 1, an example architecture 10 that supports one embodiment of the present invention is shown. Architecture 10 generally includes an inviting party 12, a call processing entity 14, and a third party call processing entity 16. Suppose that inviting party 12 in one example is a terminal, call processing entity 14 is a SIP-compliant proxy, and third party call processing entity 16 is third party server, such as a remote server, with whom a user of terminal 12 has a trust relationship. Suppose further that a user (not shown) associated with terminal 12 desires to initiate an Internet multimedia session and that terminal 12 is preconfigured to do so using SIP messaging. Also assume that SIP proxy 14 contains instructions for processing SIP messages and that the instructions are written in the computer language known as CPL.

Additionally, suppose that the user in this example does not know the address for the entity he wishes to call, but that he has set up on third party 16 a database linking a keyword to a SIP address for various entities or persons he may desire to call. As such, third party 16 includes third party processing logic 18 that can evaluate a keyword provided in a SIP message and return the associated SIP address. In addition, terminal 12 includes programming for receiving input from the user that indicates a desire to place a call to an entity associated with, for example, the keyword “news.” After receiving such input, terminal 12 can create a SIP INVITE message 20 that includes a trigger 26, which includes the keyword “news.”

Call processing generally proceeds as follows, but will be discussed in more detail later. In general, to initiate the call, terminal 12 creates and transmits 22 INVITE message 20 to SIP Proxy 14. Upon reception of INVITE message 20, SIP Proxy 14 executes a user-specific CPL Script 24. In following the instructions of CPL Script 24, SIP Proxy 14 detects trigger 26 within SIP message 20, which causes an extension-switch 28 in CPL script 24 to be executed. Extension-switch 28 transfers call processing by forwarding SIP INVITE message 20 to third party 16. The message 20 is preferably encapsulated and transmitted via secure link. Upon reception of INVITE message 20, third party 16 evaluates keyword “news” and, according to its call processing logic 18, returns an address associated with the keyword to SIP Proxy 14 as part of an extension-result message 30. After SIP Proxy 14 receives extension-result 30, which includes a destination address, it continues call processing as it would for a standard SIP INVITE message.

As discussed, SIP INVITE message 20 may include one or more triggers 26. Trigger 26 may include a keyword, such as the example “news,” or it may include numerous other identifiers that are set up to be recognized as a trigger by a call processing entity. For example, triggers may include flags within certain fields of INVITE message 20. They could be keywords, specific addresses, time entries, registration information of the invited party, or numerous other examples. In accordance with the keyword example, one or more keywords are included in a subfield of the SIP INVITE message 20 in the “original-destination” or “destination” field. The keyword subfield may, for example, be a string in the format “keyword:word1 keyword:word2 keyword:word3 . . . ” In such an example, three keywords would be transmitted as part of the SIP INVITE message 20. The keywords may constitute one or more triggers depending on the programming of CPL script 24.

In the example of an outgoing session initiation request shown in FIG. 1, terminal 12 creates the session initiation request embodied in this example as SIP INVITE message 20. As shown in FIG. 4, terminal 12 generally includes a communications interface 32, inputs (e.g. keypad 36 and audio/visual inputs 34), display 38, memory 40, and processor 42. The communications interface 32 is adapted to communicate with SIP Proxy 14. Stored within memory 40 are instructions for receiving session initiation instructions, creating a session initiation message 20, and transmitting the message 20 to SIP Proxy 14. According to the keyword example, the keyword could be input via audio inputs 34 such as through voice recognition technologies, via keypad 36, or via other terminal interfaces such as a mouse (not shown). The terminal 12 could be a mobile terminal, such as a handheld computer or mobile telephone, a desktop PC, a laptop computer, a server, etc.

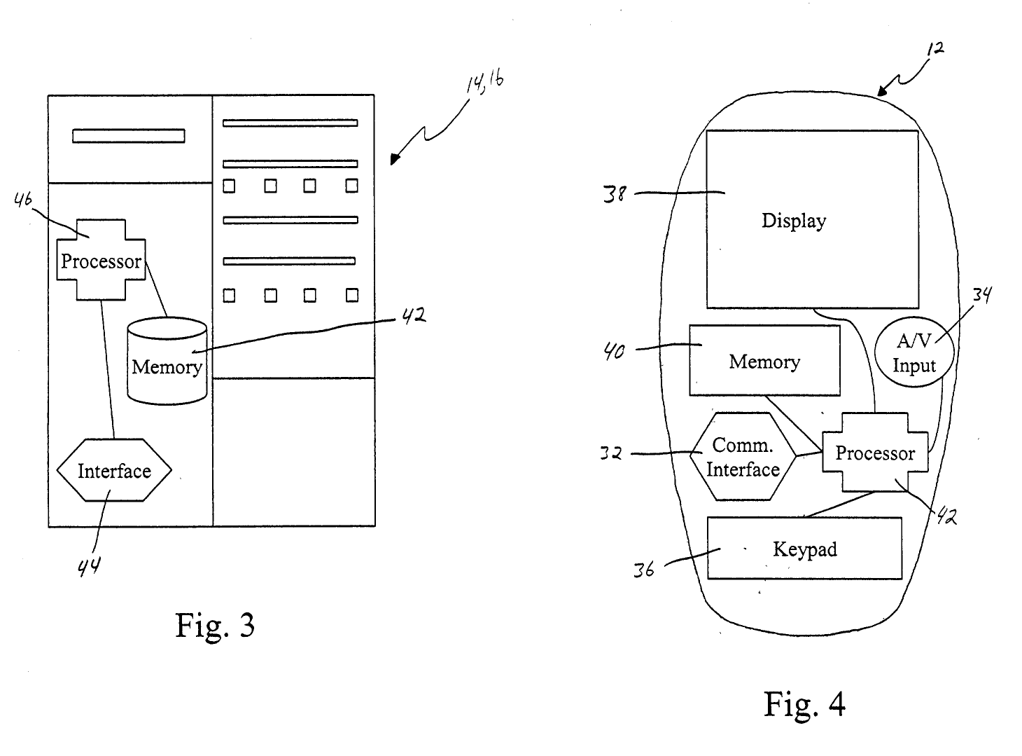

The call processing entity 14 may include a SIP-compliant proxy 14. As shown in FIG. 3, such a proxy 14 may generally include memory 42, a processor 46, and a communications interface 44 for communicating with terminal 12 and third party 16. Stored within memory 42 are instructions for processing the SIP INVITE message 20.

According to one embodiment, the instructions include a script 24 written in the language known as CPL. As CPL is an XML based language, also stored in memory 42 is an XML interpreter 48 for parsing and executing the CPL script 24. In one embodiment, it is possible to use a single script for a certain group of users, rather than invoking a distinct CPL script for each user. In this case, the SIP INVITE message 20 includes the entire user-specific information, such as the address of the desired third party 16.

In order to support the approach of the present invention according to one variation, two language elements are added to CPL to define the underlying communication between the SIP-compliant proxy 14 and third party 16. CPL is used in embodiments described herein, but is not intended to be limiting. Further, the use of CPL in these embodiments is not intended to exclude any other call processing languages capable of interworking with SIP-compliant proxies or other call processing entities.

The first element added to CPL transfers the current call information to a third party 16, which performs, for example, keyword based call processing. The second element is a mechanism to return the results of the call processing performed by third party 16 to SIP proxy 14. The SIP proxy 14 is then able to use the results to complete call processing without processing, for example, keyword-related data. In another example, SIP proxy 14 avoids processing context-specific data, such as highly confidential personal data, thus ensuring that user's privacy is maintained and that CPL is kept simple. Highly confidential personal data can include, for example, password information related to a particular callee, health data such as current blood pressure and pulse rate, etc. Using informal syntax, the following two elements are defined in CPL to effect and support the present invention:

Node: extension-switch

Outputs: extension-result

Parameter: URL

Output: extension-result

Parameter: is

The format of the information transmitted to third party 16 is not specifically defined herein in order to keep it as generic as possible. However, a string-based mechanism is assumed hereinafter for ease of description. It should be further noted that SIP proxy 14 and third party 16 are not necessarily physically separate devices so that they may be realized in a common device. That is, SIP proxy 14 and third party 16 are logically separate entities, but they do not need to be implemented in physically separate devices. As a physically separate device, third party 16 may generally be configured similar to call processing entity 14. That is, as shown in FIG. 3, it may be a proxy server 16 that generally includes memory 42, processor 46 and a communications interface 44 for communicating with call processing entity 14.

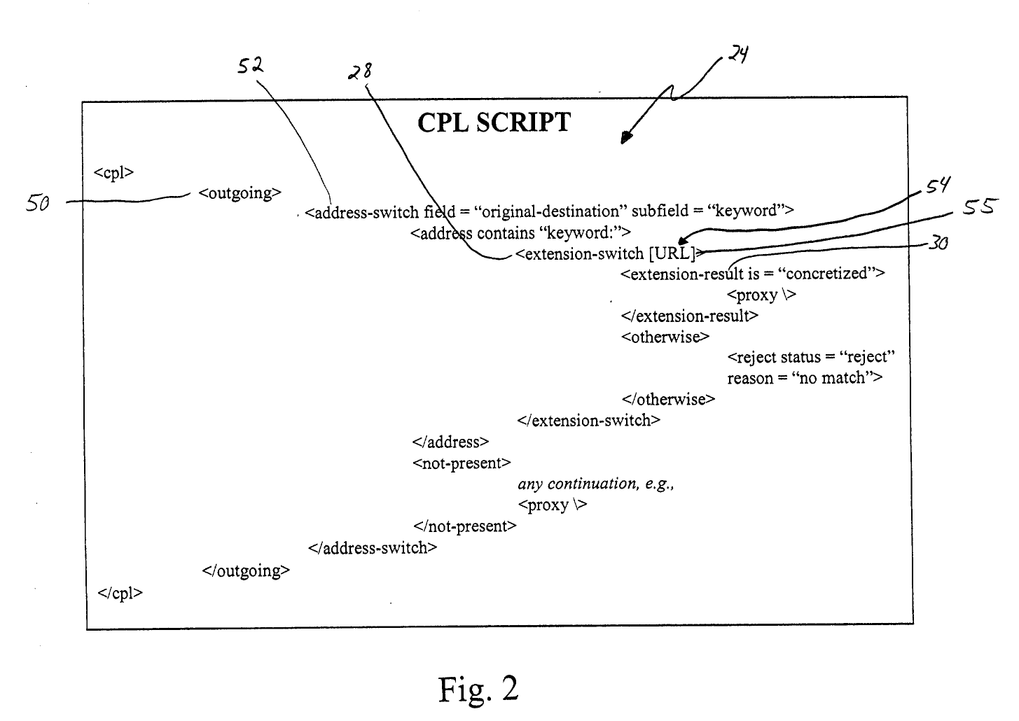

Referring specifically to FIG. 2, a user-specific CPL script 24 for the keyword example is shown. Because this example involves an outgoing SIP INVITE message 20, the outgoing action 50 of CPL script 24 is executed. CPL scripts generally include a hierarchy of call processing actions, which include top-level actions and subactions. Top-level actions, such as outgoing action 50, are triggered by signaling events within an incoming message, such as message 20, whereas subactions can be called from other actions. According to one embodiment, as CPL script 24 is processed, an outgoing action 50 calls a subaction, address-switch 52, which tests for the presence of a keyword in the original-destination field of SIP INVITE message 20. Other examples of subaction switches that could be called to test for the presence of a trigger may include a time-switch, a priority-switch, or a location-switch. Upon detection of the keyword trigger by address-switch 52, extension-switch element 28 is called, which initiates the transfer of the current call processing information to the URL 54 specified as a parameter 55 of extension-switch 28. It is assumed for purposes of this description that there is a security association between the SIP proxy 14 and the third party 16 specified by the URL 54. It should be noted that since a number of actions may exist to test for a variety of different triggers, a number of corresponding extension-switch elements may exist.

After third party 16 processes INVITE message 20, it returns an extension-result element 30, containing (based on the keyword) the modified call information. As shown in FIG. 2, extension-result element may also include, as an example, a (string-based) indication that the destination address is “concretized,” which indicates that a final destination address could be determined during the call processing in third party 16. Once the destination address is returned by extension-result 30, the SIP proxy 14 is able to take appropriate follow-up call processing actions, such as call redirection and call rejection, based on simple string comparisons.

In the context of the keyword example, the third party call processing is keyword specific so the extension-result 30 is a keyword result. For example, if only a keyword trigger is contained in SIP INVITE message 20, only an extension-switch related to the keyword will be executed. The SIP INVITE message 20 will therefore be transferred to a keyword-related URI (e.g. third party 16), which is represented by URL 54 specified in an associated extension-switch parameter 55. Based on the keyword, third party 16 performs processing logic and returns an address in the destination field of the SIP INVITE message. The processing may be more involved and may include the use of more than one trigger.

Suppose, for example, that third party call processing logic 18 also included an evaluation of context specific information, such as indications of the mood of the user or the current time. In such scenarios, the third party call processing is context-specific so the extension-switch is a context-switch. For example, suppose terminal 12 independently communicates with third party 16 to provide context specific information, such as health information related to the user's mood. Using the “news” keyword scenario, upon reception of the INVITE message 20 as part of extension-switch 28 and based on communications between terminal 12 and third party 16, third party 16 may determine that the user is more likely to appreciate news regarding lifestyle and art rather than the latest tragedy. As such, the extension-result 30 may return a context appropriate news address.

In another example, the current time could also be a context related factor considered by third party call processing logic 18. Additional keywords or triggers may also provide factors for use by third party call processing logic 18. Further, the results returned are context-specific so the extension-result is a context-result. It should be noted that other call processing functions other than those functions that are context-specific are possible. That is, the context-specific call processing described herein is exemplary and not intended to limit the uses or types of functions that can be processed by a third party call process entity.

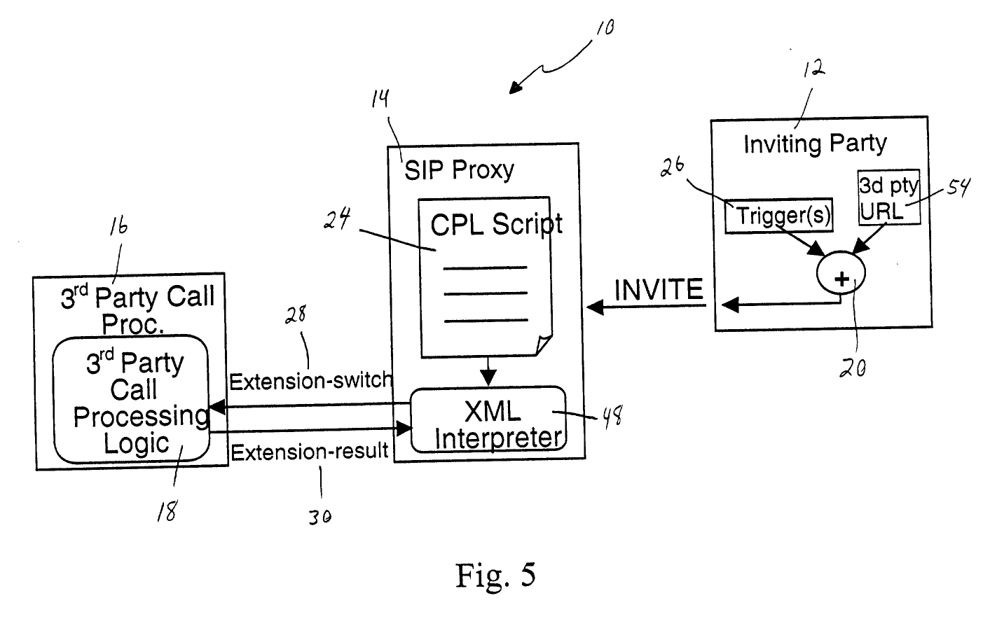

Referring now to FIG. 5, example architecture 10 supporting another embodiment of the present invention is shown, which differs from the previous embodiment in that third party URI, which is represented by URL 54, is contained in SIP INVITE message 20. This also permits the CPL script to be more flexible since the user of terminal 12 is able to dynamically specify one or more third parties 16 for performing call processing related to one or more triggers 26 rather than uploading a new CPL script with the particular URLs 54.

As with the previous embodiment, based on inputs from a user, terminal 12 creates a SIP INVITE message 20. The INVITE message 20, however, includes a third party URI, such as URL 54, in addition to one or more triggers 26. Preferably, URL 54 is included in the original-destination or destination fields (not shown) of the INVITE message 20, which is transmitted to SIP proxy 14. Upon reception of INVITE message 20, SIP proxy 14 executes CPL script 24. Accordingly, XML interpreter 48 parses and translates the CPL language elements. Once trigger 26 is detected in INVITE message 20, extension-switch 28 is called and processed, thereby transferring call processing to third party 16. In processing extension-switch 28, extension-switch parameter 55 (see FIG. 2) refers to either the original-destination or the destination field (not shown) of the INVITE message 20. As such, call processing is transferred to the third party 16 located at URL 54 specified in the INVITE message.

As with the previous embodiment, third party 16 performs call processing according to third party call processing logic 18 and returns (extension-result 30) call processing to XML interpreter 48. The message transfers between SIP proxy 14 and third party 16 preferably include encapsulating the entire INVITE message 20. Alternatively, however, only portions relevant to third party processing may be transferred. Further, additional information, such as processing instructions, may be included in the encapsulated message.

The extension-result 30 may include the result (or action to be taken) or alternatively, a separate extension-result parameter may be defined. The action to be taken may then be decoded by SIP proxy 14. The decoding may be accomplished using a string comparison if the extension-result 30 and/or an extension-result parameter are in string form. Alternative decoding techniques include bit testing, bit manipulation, or any other character and arithmetic decoding techniques.

The extension-switch 28 and extension-result 30 parameters may be integrated in current SIP-compliant implementations, specifically in the CPL parser block.

Additionally, the functionality to parse these elements can be added to the CPL language definition in XML parsers (interpreters). Finally, transfer capabilities between SIP proxy 14 and third party 16 may be implemented in SIP proxy 14. Because the entire SIP call control message flow is standardized, the elements 28, 30 are easily detected.

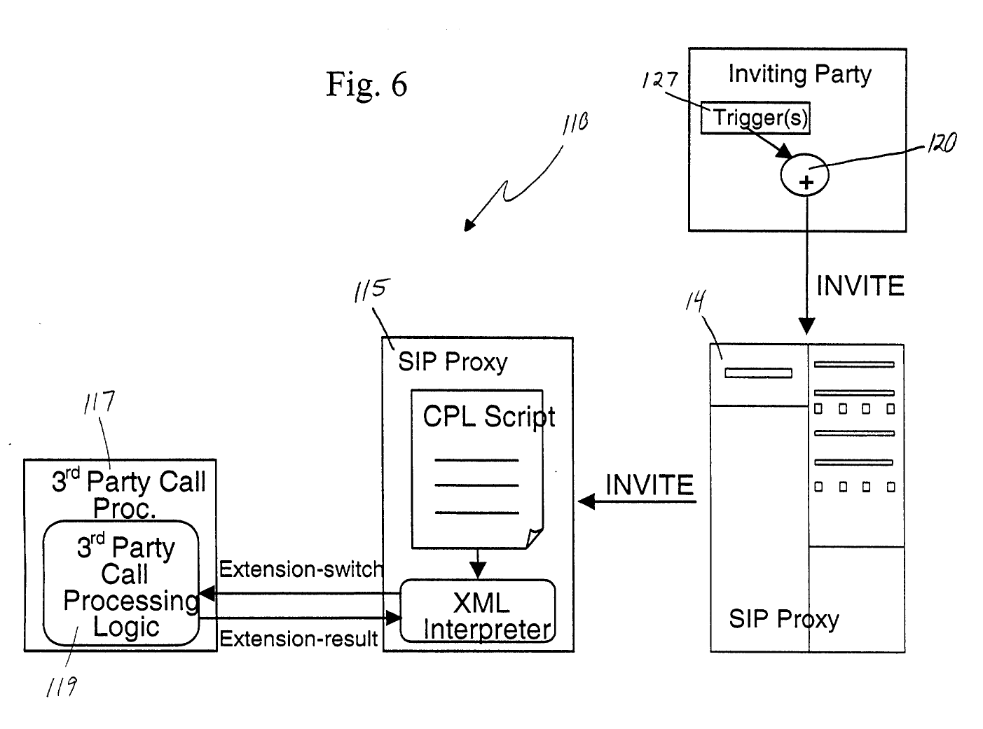

Referring now to FIG. 6, another example architecture 110 supporting a further embodiment of the present invention is shown, which differs from the previous embodiments in that actions are being taken in SIP Proxy 115 as a result of receiving an incoming INVITE message 120. As such, INVITE message 120 includes one or more triggers 127 that cause actions to be taken in SIP proxy 115. SIP proxy 115 hosts the invitee (not shown), rather than in the previous examples where SIP proxy 14 hosts inviting party terminal 12. Except for aspects relating to incoming rather than outgoing INVITE messages, all aspects and preferences are generally the same as those discussed with relation to the other embodiments and examples. Further, this embodiment may be used along with one of the previous embodiments. For example, multiple triggers 26, 127 may be included in INVITE message 120, some of which cause actions to be taken in SIP proxy 14 and others that cause actions to be taken in SIP proxy 115. Third party 117 in this example is related to the invitee (not shown) and performs actions according to its third party processing logic on behalf of the invitee.

While the present invention has been described in connection with the illustrated embodiments, it will appreciated and understood that modifications may be made without departing from the true spirit and scope of the invention. In particular, the invention may apply to different types of session initiation requests, call processing languages, call processing entities, and terminals. Additionally, the triggers may take various forms and the third parties may perform a wide variety of call processing.

We claim:

1. A method of performing Internet call processing for a call processing entity comprising the steps of:
detecting a session initiation request comprising at least one call transfer trigger;
executing a call processing language script;
detecting said at least one call transfer trigger;
in response to detecting said at least one call transfer trigger, transferring call processing to a third-party call processing entity;
receiving a result from said third-party call processing entity; and
continuing said call processing based on said result.

2. The method according to claim 1, wherein said call transfer trigger comprises at least one keyword.

3. The method according to claim 2, wherein call processing performed by said third-party call processing entity is based on said at least one keyword.

4. The method according to claim 3, wherein said result comprises an address related to said at least one keyword.

5. The method according to claim 1, wherein said session initiation request comprises an outgoing session initiation request.

6. The method according to claim 1, wherein said session initiation request comprises an incoming session initiation request.

7. The method of claim 1, wherein said session initiation request comprises a session initiation protocol (SIP) INVITE message.

8. The method of claim 1, wherein said step of detecting said at least one call transfer trigger comprises the step of executing at least one action switch, said at least one action switch testing for the presence of said at least one call transfer trigger within said session initiation request.

9. The method of claim 8, wherein said call processing language is the language known as CPL and said at least one action switch is selected from the group consisting of an address-switch, a time-switch, a priority-switch, and a location-switch.

10. The method according to claim 9, wherein said step of transferring call processing comprises the step of executing at least one call transfer switch

11. The method according to claim 10, wherein said at least one call transfer switch comprises an extension-switch.

12. The method according to claim 11, wherein said step of executing at least one extension-switch comprises the step of detecting an extension-switch parameter associated with said at least one extension-switch.

13. The method according to claim 12, wherein said extension-switch parameter comprises a Uniform Resource Identifier (URI) for said third-party call processing entity.

14. The method according to claim 13, wherein said extension-switch parameter URI comprises a URI provided by said session initiation request.

15. The method according to claim 14, wherein said extension-switch parameter URI comprises a URI provided in an original-destination field of said session initiation request.

16. The method according to claim 14, wherein said extension-switch parameter URI comprises a URI provided in a destination field of said session initiation request.

17. The method according to claim 11, wherein said at least one extension-switch comprises an extension-switch associated with said trigger.

18. The method according to claim 1, wherein said step of transferring call processing comprises the steps of:
encapsulating at least a portion of said session initiation request into a third-party message; and
transmitting said third-party message to said at least one third-party call processing entity.

19. The method according to claim 18, wherein said third-party message comprises said call transfer trigger.

20. The method according to claim 1, wherein said call processing language is the language known as CPL and for said step of receiving a result, said result comprises an extension-result.

21. The method according to claim 20, wherein said extension-result comprises at least one extension-result parameter.

22. The method according to claim 21, wherein said at least one extension-result parameter comprises a destination address.

23. The method according to claim 21, wherein said extension-result comprises an indication that said destination address comprises a concrete destination address.

24. The method according to claim 1, wherein said third-party call processing entity comprises an external third-party call processing entity.

25. The method according to claim 1, wherein call processing performed by said third-party call processing entity is context-specific.

26. The method according to claim 25, wherein call processing performed by said third-party call processing entity uses highly confidential personal data.

27. A method for performing Internet call processing functions in a third-party call processing entity based on a session initiation request forwarded by a call processing entity, said session initiation request comprising at least one call transfer trigger, the method comprising the steps of:
receiving a third-party message requesting call processing for said session initiation request, said third-party message comprising at least a portion of said session initiation request, which comprises said at least one call transfer trigger;
executing requested call processing functions based on said at least one call transfer trigger; and
returning a result to said call processing entity.

28. The method according to claim 27, wherein said result comprises a destination address.

29. The method according to claim 28, wherein said result comprises an indication that said destination address comprises a concrete address.

30. The method according to claim 27, wherein said result comprises at least one parameter.

31. The method according to claim 30, wherein said at least one parameter comprises a destination address.

32. The method according to claim 27, wherein said at least one call transfer trigger comprises at least one keyword, said at least a portion of said session initiation request comprises said at least one keyword, said step of executing requested call processing functions comprises the step of determining a destination address based on said at least one keyword, and said result includes said destination address.

33. The method according to claim 27, wherein said requested call processing is context-specific.

34. A computer readable medium having computer-executable instructions for performing steps related to Internet call processing, said steps comprising:
in response to reception of a session initiation request comprising at least one call transfer trigger, detecting said call transfer trigger;
in response to detecting said at least one call transfer trigger, transferring call processing to at least one third-party call processing entity; and
in response to reception of a result from said at least one third-party call processing entity, completing said call processing based on said result.

35. The computer readable medium according to claim 34, wherein said step of detecting said call transfer information comprises the step of executing at least one action switch, said at least one action switch testing for the presence of said at least one trigger within said session initiation request.

36. The computer readable medium according to claim 34, wherein said computer readable instructions are in the language known as CPL and said step of transferring call processing comprises the step of executing at least one extension-switch.

37. The computer readable medium according to claim 34, wherein said step of transferring call processing comprises the steps of:
encapsulating at least a portion of said session initiation request into a third-party message; and
transmitting said third-party message to said at least one third-party call processing entity.

38. A computer readable medium having computer-executable instructions for performing steps related to Internet call processing at a third-party processing entity, the steps comprising:
receiving a message from a call processing entity requesting call processing for a session initiation request comprising at least one trigger, said message comprising at least a portion of the session initiation request,
executing requested call processing functions; and
returning a result to said call processing entity.

39. A call processing entity comprising:
a storage medium;
a communications interface; and
a processor for performing steps relating to Internet call processing, said steps comprising:
detecting a session initiation request received via said communications interface, said session initiation request comprising at least one call transfer trigger;
executing a call processing language script stored in said storage medium;
detecting said at least one call transfer trigger;
in response to detecting said at least one call transfer trigger, transferring call processing to at least one third-party call processing entity;
receiving a result from said at least one third-party call processing entity; and
continuing said call processing based on said result.

40. A communications terminal for participating in Internet calls and adapted to initiate an Internet call using a session initiation protocol (SIP), said terminal comprising:
a communications interface adapted to communicate with a SIP-compliant proxy;
an input device; and
a processor for performing steps comprising:
receiving instructions via said input device for initiating an Internet call;
based on said instructions, creating a session initiation request comprising at least one call transfer trigger; and
transmitting said session initiation request to said SIP-compliant proxy via said communications interface.

41. The communications terminal according to claim 40, wherein said session initiation request further comprises an address for a third-party call processing entity.

42. The communications terminal according to claim 40, wherein said at least one trigger comprises at least one keyword.
